(19) United States
(12) Patent Application Publication
(10) Pub. No.: US 2026/0320452 A1
(43) Pub. Date: Oct. 15, 2026

(54) Reality-Advancing Engineering System with Governed Micro-Reality Constitution and Lineage-Preserving Supersession

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/464,345

(22) Filed: Jan. 29, 2026

(51) Int. Cl. G06N 5/048; G06N 3/126

(52) U.S. Cl. CPC G06N 5/048; G06N 3/126

(57) ABSTRACT

A continuously running system-resident engineering environment embodied in non-transitory machine memory establishes and maintains a governed reality-advancing factual-existence infrastructure in which system-resident realities are constituted as protected system artifacts. Internal and external occurrences are admitted only through governed ingress and normalization. A fuzzy initial factual existence Rₒ is constituted, from which evolutionary micro-reality factual existences are successively constituted as closed micro-existence bodies forming discrete micro-steps of system-recognized reality advancement. Canonical system realities are advanced only through governed atomic supersession preserving lineage. Evolving system memory substrates preserve constituted realities, historical realities, and micro-realities as a system-resident reality substrate. Purpose realities form a directional attractor field and constituted canonical realities form a resultant attractor field. Internal and external resources provide only governed result memories. Evolutionary micro-realities, bounded stage realities, and canonical realities are exposed as system-resident reality expressions selectively usable and convertible into any external form without surrender of system reality jurisdiction.

### CROSS-REFERENCE TO RELATED APPLICATIONS

This application claims no priority to, and does not incorporate by reference, any prior or co-pending application.

The disclosure is presented as a standalone invention directed to continuously running, system-resident engineering environments embodied in non-transitory machine memory, establishing a new system class in which system reality itself is constituted, preserved, inherited, and superseded under exclusive system jurisdiction.

### PRIOR ART

The following references are provided as a non-exhaustive prior-art list. The list emphasizes provenance, lineage, traceability, auditability, immutable/append-only records, secure logging/timestamping, and related governance/record-integrity infrastructures that are commonly cited in the broader field. The list is not an admission that any reference is material, relevant, or constitutes prior art against any claim.

### US PATENT DOCUMENTS

U.S. Pat. No. 10,097,356 B2 October 2018 Zinder
U.S. Pat. No. 10,425,428 B2 September 2019 Krishnamurthy
U.S. Pat. No. 11,086,751 B2 August 2021 Moresmau et al.
U.S. Pat. No. 9,659,042 B2 May 2017 Puri et al.
U.S. Pat. No. 6,434,558 B1 August 2002 MacLeod et al.
U.S. Pat .No. 9,348,879 B2 May 2016 Mohammad et al.
U.S. Pat. No. 11,258,682 B2 February 2022 Kavanagh et al.
U.S. Pat. No. 8,423,965 B2 April 2013 Goel et al.
U.S. Pat. No. 8,799,873 B2 August 2014 Carey et al.
U.S. Pat. No. 7,962,709 B2 June 2011 Agrawal et al.
U.S. Pat. No. 10,884,900 B2 January 2021 Barsness et al.
U.S. Pat. No. 10,235,274 B1 March 2019 Quievryn et al.
U.S. Pat. No. 10,033,702 B2 July 2018 Ford et al.
U.S. Pat. No. 10,402,792 B2 September 2019 Lin et al.
U.S. Pat. No. 11,232,414 B2 January 2022 Metnick et al.
U.S. Pat. No. 2016/0300234 A1 October 2016 Moss-Pultz et al.
U.S. Pat. No. 9,667,427 B2 May 2017 Oberhauser et al.
U.S. Pat. No. 10,540,654 B1 January 2020 James et al.
U.S. Pat. No. 11,606,219 B2 March 2023 Wright et al.

### FOREIGN PATENT DOCUMENTS

CN 110,226,168 B May 2023 Little et al.
CN 113,010,906 B October 2023 Lai et al.

### BACKGROUND OF THE INVENTION

Contemporary computing and engineering systems are constructed on paradigms in which “reality” exists outside the system and is represented internally as data, variables, states, models, simulations, or control abstractions. In such systems, internal constructs are treated as informational surrogates whose correctness depends on correspondence to an external world.

As a result, construction, continuity, and advancement of reality in conventional systems are inseparable from algorithms, inference engines, learning procedures, optimization routines, simulation execution, or control loops. System evolution proceeds through recomputation, retraining, re-estimation, or re-optimization of representational structures. No protected internal reality exists that can be constituted, inherited, sealed, or superseded as factual existence under exclusive system jurisdiction.

Existing architectures therefore lack structural mechanisms for micro-reality constitution as closed factual existence bodies, lineage-preserving supersession of canonical realities, memory as an evolving reality substrate, or axiomatic admissibility governance. They further lack mechanisms by which intelligent, analytical, or simulation technologies are structurally subordinated as governed result-memory generators rather than as authorities over reality.

Accordingly, a fundamental architectural absence remains in current engineering systems: the absence of a continuously running system-resident environment in which reality itself is constituted, preserved, inherited, evolved, adjudicated, and replaced as a protected system artifact.

The present disclosure addresses this absence.

### SUMMARY OF THE INVENTION

The disclosed subject matter establishes a continuously running, system-resident engineering environment embodied in non-transitory machine memory that constitutes and advances system-resident reality as a protected internal system artifact rather than as a computed state, model, representation, or informational object.

The disclosed system establishes and maintains a governed reality-advancing factual-existence infrastructure comprising protected execution regions, evolving system memory substrates, and governance-enforced constitution and supersession engines under exclusive system jurisdiction.

All internal and external occurrences of any form are admitted only through governed ingress and normalization and are constituted into system-recognized governed factual expressions prior to participation in reality formation. From admitted factual expressions, the system constitutes at least one task-specific initial factual existence R_{O} forming a fuzzy initial reality participation existence admissible under axiomatic boundaries.

System-resident reality is constituted not as an updatable system state, but as an aggregation of evolutionary micro-reality factual existences. Evolutionary micro-reality units are successively constituted as bounded closed factual existence bodies forming discrete micro-steps of system-recognized reality advancement and continuous fact-flow. Selected micro-realities satisfying governance and consolidation constraints are constituted as bounded stage realities.

The system maintains purpose realities forming a directional attractor field and constituted canonical realities forming a resultant attractor field. Canonical realities advance only through governed atomic supersession preserving lineage. Evolving system memory substrates preserve constituted realities as a reality substrate. Internal and external resources provide only governed result memories. System-resident realities are exposed as selectable multi-stage reality expressions convertible into any external form without surrender of system reality jurisdiction.

### BRIEF DESCRIPTION OF DRAWINGS

FIG. 1—External Boundary and System-Resident Reality Jurisdiction

FIG. 2—Governed Ingress and R₀ Fuzzy Reality Formation

FIG. 3—Canonical Reality Register, Sealing, and Exclusive Constitution Authority

FIG. 4—Evolutionary Micro-Reality Units as Closed Micro-Existence Bodies

FIG. 5—Micro-Step Fact-Flow, Consolidation, and Selectable Outputs

FIG. 6—Lineage-Preserving Canonical Supersession

FIG. 7—Dual Attractor Fields, Axioms, and Micro-Axiom Constitution

FIG. 8—Evolving Memory Substrates as Reality Substrate

FIG. 9—Governed Resource Collaboration as Result-Memory Admission

FIG. 10—Monitoring, Adjudication, Multi-Stage Output, Conversion, and Re-Admission

### DETAILED DESCRIPTION OF THE INVENTION

The figures of this Section illustrate representative structural constitutions of continuously running, system-resident reality-advancing engineering environments embodied in non-transitory machine memory.

The figures declare protected system-resident infrastructures through which canonical system reality is constituted, preserved, inherited, evolved, adjudicated, and superseded under exclusive system jurisdiction, wherein factual existences and micro-factual existences operate as the system ontology, memory operates as a reality substrate, and reasoning, evolution, and adjudication operate as system-resident motive and boundary infrastructures governed under axioms.

The figures do not depict algorithms, workflows, data pipelines, task procedures, optimization logic, learning loops, or control sequences. The figures illustrate governed ingress and normalization, fuzzy R₀ admission, multi-axiomatic governance and micro-axiom constitution, micro-reality units as closed factual existence bodies, micro-step resolution and selectable multi-stage outputs, lineage-preserving canonical supersession, evolving memory substrates including micro-memory and instantaneous memory, governed collaboration with internal and external resources as result-memory sources, monitoring and adjudication structures, and reality expression exposure, conversion, and beneficiary selection.

Nothing in this Section shall be interpreted as limiting the disclosed systems to any specific hardware, software, network, intelligence paradigm, computational model, data structure, simulation method, learning method, or industrial domain. Any illustrated structure may be implemented in centralized, distributed, embedded, cyber-physical, biological, material, quantum, hybrid, federated, or future-developed technological environments.

All external and internal inputs are governed into system-recognized factual expressions prior to admission into reality formation. Outputs generated by internal or external resources and technologies are admitted only as governed result memories and are structurally prevented from directly constituting, replacing, or designating canonical system reality. Canonical system reality is constituted and advanced only by system-resident constitution and supersession structures operating within protected execution regions under exclusive system jurisdiction.

All outputs of the disclosed system are system-resident reality expressions. Outputs are not limited to a final result. Micro-reality units, bounded stage realities, and canonical realities may each be individually exposable, selectively usable by authorized entities or beneficiaries, optionally re-admitted as new governed occurrences for further reality-advancement cycles, and optionally converted into any external form without surrender of system-resident reality jurisdiction.

The figures of this Section are expressed as single-direction structural logic diagrams.

The illustrated directional relations do not represent operational steps, process flows, algorithms, control sequences, or execution orders. The illustrated relations declare structural and jurisdictional constraints through which system-resident reality is constituted, preserved, inherited, evolved, adjudicated, and superseded under exclusive system jurisdiction.

The illustrated relations express non-reversible system-resident reality constitution directions. No illustrated relation implies any reverse reality path from constituted system reality domains to external environments, nor any external write-back path capable of bypassing system-resident reality constitution infrastructures.

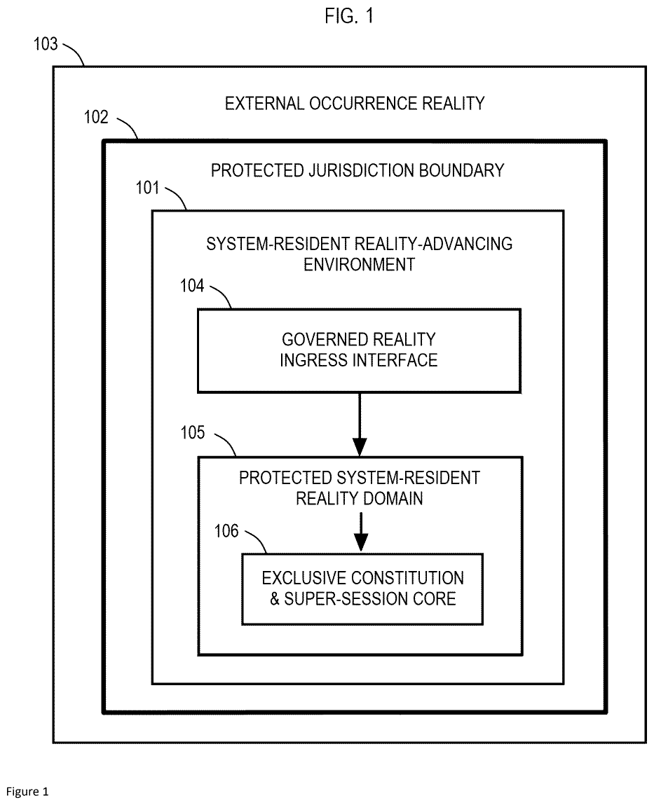

FIG. 1 illustrates a continuously running system-resident reality-advancing environment 101 embodied in non-transitory machine memory, wherein the environment establishes a protected jurisdiction boundary 102 defining exclusive authority over constitution, supersession, sealing, registration, and designation of canonical system reality.

The illustrated structure comprises an external occurrence reality 103, a governed reality ingress interface 104, a protected system-resident reality domain 105, and an exclusive constitution and supersession core 106 operating within protected execution regions.

The illustrated structure establishes that external occurrences are not admitted as ungoverned data objects, task parameters, or computational states, and that any participation of external occurrences in reality formation occurs only after governance-conditioned normalization into system-recognized factual expressions within the governed ingress interface 104.

The illustrated structure further establishes that canonical system reality within the protected system-resident reality domain 105 is a system-resident factual existence under exclusive system jurisdiction and is not a model, simulation, representation, updatable system state, or inferred depiction of external reality.

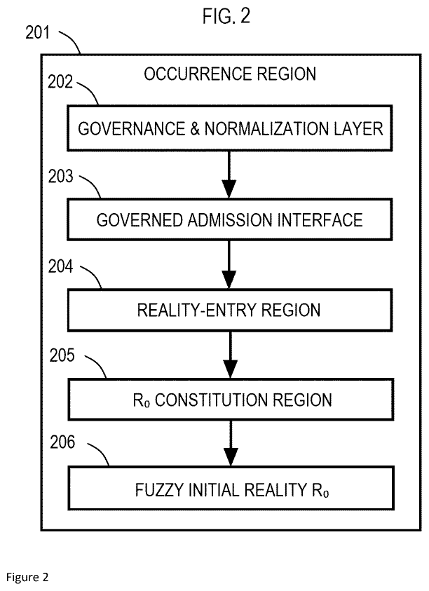

FIG. 2 illustrates a governed admission architecture beginning at an occurrence region 201 and extending through a governance and normalization layer 202 to a governed admission interface 203 and a reality-entry region 204.

The governance and normalization layer 202 constitutes incoming occurrences into system-recognized governed factual expressions and enforces admissibility boundaries under axioms prior to any participation in reality formation.

The illustrated structure further comprises an R₀ constitution region 205 configured to constitute at least one task-specific initial factual existence R₀ 206 forming a fuzzy initial reality participation state.

The illustrated structure establishes that fuzziness of R₀ is treated as limited maturity of an admitted factual existence rather than as error, and that R₀ is not treated as a goal specification, parameter set, model state, optimization target, knowledge representation, or computational state.

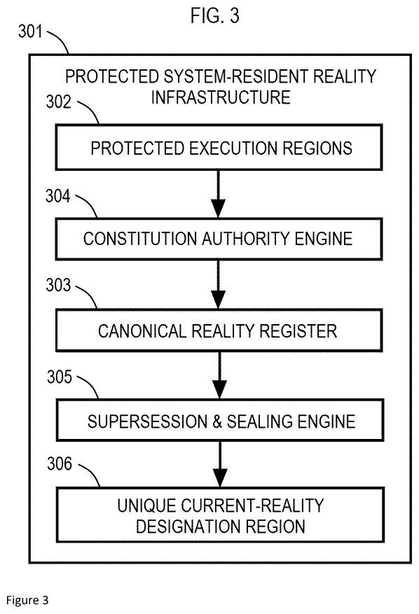

FIG. 3 illustrates a protected system-resident reality infrastructure 301 comprising protected execution regions 302, a canonical reality register 303, a constitution authority engine 304, and a supersession and sealing engine 305.

The canonical reality register 303 maintains system-resident realities as materially maintained reality constructs that are registered, version-addressed, and jurisdiction-tagged as realities rather than as data records.

The constitution authority engine 304 is configured as the exclusive system-resident authority that may introduce a newly constituted reality construct into the canonical reality register 303 under axiomatic and governance constraints, and is structurally separated from peripheral capabilities and from the occurrence region.

The supersession and sealing engine 305 is configured to seal a prior canonical reality as a sealed historical factual existence and to install a successor canonical reality as the current canonical reality while preserving lineage relations and inheritance constraints.

The illustrated structure further comprises a unique current-reality designation region 306 configured to designate, at any given time, exactly one constituted canonical system reality as the current system reality under exclusive system jurisdiction.

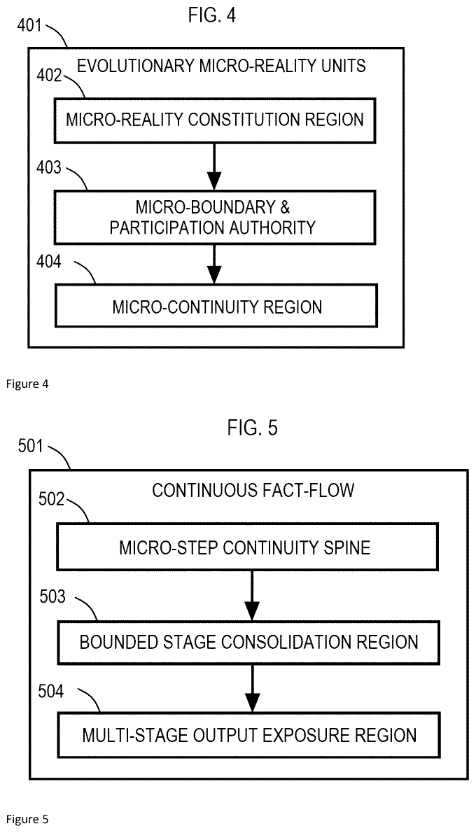

FIG. 4 illustrates evolutionary micro-reality units 401 constituted from R₀-derived factual existences as minimal system-recognized reality participation bodies.

Each evolutionary micro-reality unit constitutes a discrete micro-step of system-recognized reality advancement and a bounded self-contained closed micro-reality factual existence body.

The illustrated structure comprises a micro-reality constitution region 402, a micro-boundary and participation authority region 403, and a micro-continuity region 404 maintaining internal continuity relations that render each unit a closed factual existence loop.

The illustrated structure establishes that micro-reality units are not processing nodes, execution stages, decision steps, or control units, and are not representable as data objects, event records, or computational states.

FIG. 5 illustrates continuous fact-flow 501 formed by successive evolutionary micro-reality units.

The illustrated structure comprises a micro-step continuity spine 502 linking successive micro-reality units, a bounded stage consolidation region 503 configured to constitute bounded stage realities from selected micro-realities satisfying governance, continuity, stability, or consolidation constraints, and an output exposure region 504 configured to expose selectable outputs at multiple maturity levels.

The illustrated structure establishes that all bounded stage realities are micro-step realities, but not all micro-step realities constitute bounded stage realities, and that high-resolution contexts may lawfully expose high-density micro-step outputs without requiring bounded stage formation.

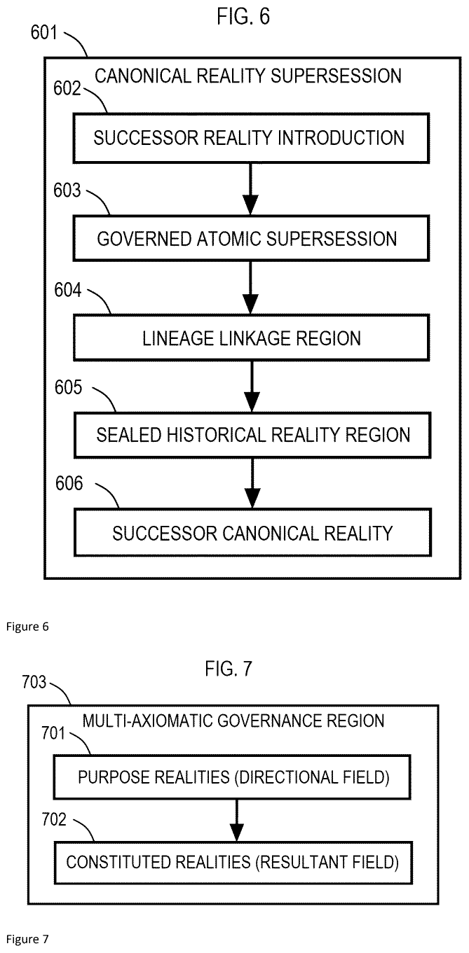

FIG. 6 illustrates canonical reality supersession 601 in which canonical system reality is not modified in place and advances only through governed atomic supersession.

The illustrated structure comprises a successor reality introduction region 602, a governed atomic supersession region 603, a lineage linkage region 604, a sealed historical reality region 605, and a successor canonical reality region 606.

The illustrated structure establishes that historical realities are sealed prior factual existences and are not logs or event records, and that lineage preservation is a constitutive reality relation maintained within system-resident memory substrates.

FIG. 7 illustrates dual system-resident reality fields comprising purpose realities 701 forming a directional attractor field and constituted canonical and bounded realities 702 forming a resultant attractor field.

The illustrated structure further comprises a multi-axiomatic governance region 703 configured to maintain superior axiomatic boundaries and to constitute subordinate axiomatic compressions and micro-axioms.

The illustrated structure establishes that micro-axioms are constituted factual boundaries and are not computed, inferred, derived, or parameterized.

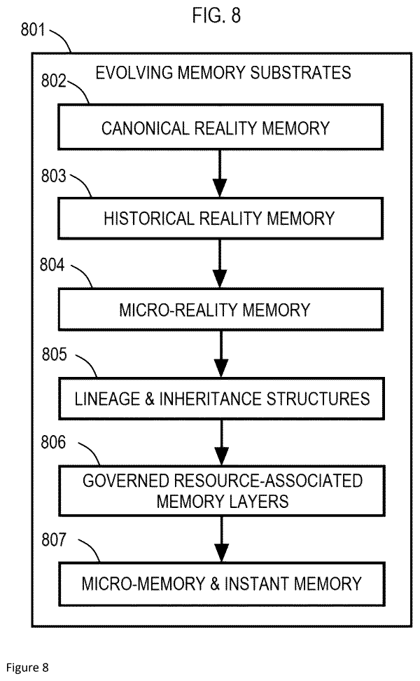

FIG. 8 illustrates evolving system memory substrates 801 preserving constituted realities, historical realities, micro-realities, lineage relations, contextual associations, and reality evolution paths as system-resident reality substrates.

The illustrated structure comprises canonical reality memory 802, historical reality memory 803, micro-reality memory 804, lineage and inheritance structures 805, governed resource-associated memory layers 806, and micro-memory and instantaneous memory structures 807.

The illustrated structure establishes that memory is not passive storage but a constitutive reality substrate carrying continuity, survivability, inheritance, and boundary relations.

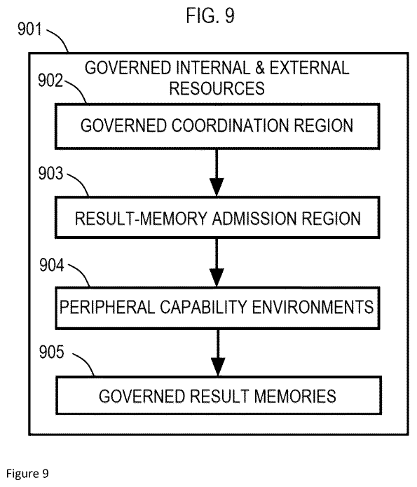

FIG. 9 illustrates governed collaboration between system-resident realities and governed internal and external resources 901 through a governed coordination region 902 and a result-memory admission region 903.

The illustrated structure further comprises peripheral capability environments 904, wherein such resources are structurally restricted to generating outputs treated solely as governed result memories 905.

The illustrated structure establishes that external resource processes do not supply authority and do not constitute, replace, designate, or reconstruct canonical system reality.

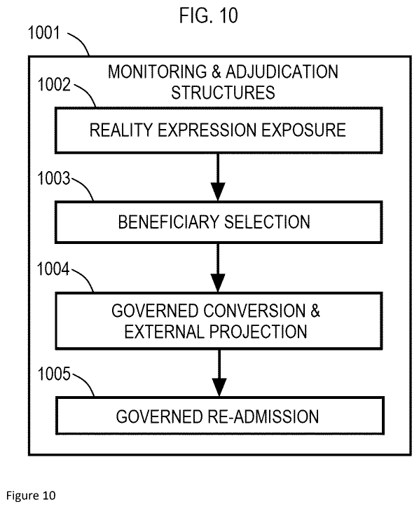

FIG. 10 illustrates system-resident monitoring and adjudication structures 1001 operating on constituted realities and memory substrates.

The illustrated structure further comprises a reality expression exposure region 1002, a beneficiary selection region 1003, a governed conversion and external projection region 1004, and a governed re-admission region 1005.

The illustrated structure establishes that outputs are inherently multi-stage, selectively exposable, optionally convertible into any external form, and optionally re-admissible for further governed reality-advancement cycles under exclusive system jurisdiction.

The disclosed subject matter relates to continuously running, system-resident engineering environments embodied in non-transitory machine memory. The disclosed systems establish machine-implemented infrastructures through which system-resident reality is constituted, preserved, inherited, evolved, adjudicated, and superseded under exclusive system jurisdiction. The disclosed systems are directed to an engineering system class in which reality is treated as a protected internal system artifact rather than as an inferred representation, a computed model, an updated system state, or a task result. Nothing herein shall be interpreted as describing or requiring any algorithm, workflow, procedure, data-processing pipeline, task plan, optimization routine, learning process, or control sequence.

The disclosed subject matter is not limited to any particular intelligence paradigm, computational model, data structure, simulation method, learning method, or industrial domain. Any described structures may be implemented in hardware, software, firmware, embedded systems, distributed systems, cyber-physical systems, networked infrastructures, biological or material substrates, quantum or classical computational substrates, hybrid environments, federated environments, or future-developed technological forms. All incoming internal or external occurrences are admitted exclusively through governed ingress and normalization structures and are not admitted as ungoverned data objects, task parameters, or computational states. Any admitted occurrence is normalized into system-recognized governed factual expressions prior to participation in reality formation. Any outputs generated by internal or external resources and technologies are admitted only as governed result memories, and are structurally prevented from directly constituting, replacing, or designating canonical system reality.

Canonical system reality is constituted and advanced only by system-resident constitution and supersession structures operating within protected execution regions under exclusive system jurisdiction. The disclosed systems expressly establish that construction, continuity, and advancement of system-resident realities are structurally removed from computational inference, learning, optimization, analytics, simulation execution, and control execution. Such capabilities may be used only as governed peripheral resources whose outputs are treated as factual result expressions subject to governance, adjudication, and memory assimilation. System outputs are system-resident reality expressions comprising constituted evolutionary micro-realities, bounded stage realities, and canonical realities. Outputs are not limited to a final result, and successive micro-reality units and bounded stage realities may each be individually exposable as system-resident reality expressions, selectable by authorized entities or beneficiaries, optionally re-admitted as new governed occurrences, and optionally converted into any external form without surrender of system reality jurisdiction.

The disclosed system is not an information processing system in which internal objects represent an external world, and instead constitutes system-resident factual existences as protected realities governed by admissibility boundaries, lineage, and supersession.

R₀ denotes a task-specific initial factual existence constituted by the system as an admitted, fuzzy participation reality within a governed reality domain. R₀ is not data, not a model state, not a goal specification, not a parameter set, and not an optimization target, but instead represents that a reality domain has entered exclusive system jurisdiction under axiomatic boundaries and governance constraints.

R₀′, R₀″, R₀′″, and higher-order derivative notations denote successive derived initial factual existences constituted by the system to initiate additional governed reality domains that are derived from, constrained by, and structurally participate in one or more previously constituted realities. Each derivative notation indicates a distinct reality-domain initiation under lineage, inheritance, participation, and constraint relations, rather than a computational iteration, procedural step, or algorithmic stage.

R₀⁴, R₀⁵, and similar superscripted forms, and any equivalent shorthand such as R04 or R05, denote deeper-order derived initial factual existences corresponding to further generations of derived reality-domain initiation within an inheritance chain, and are used solely to indicate the order of derivation within a constituted reality lineage. Such notations do not denote versions, loop counts, time steps, or state updates, and do not require any algorithm, workflow, learning process, optimization routine, or control sequence.

In the disclosed system, factual existences and evolutionary micro-factual existences operate as the internal system ontology. System reality is not composed of data objects, informational entities, variables, system states, knowledge structures, or representations. Rather, constituted factual existences and micro-factual existences form the ontological substance of the system, and evolving system memory substrates operate as reality substrates through which continuity, survivability, inheritance, feasibility, and evolution relations are materially carried.

In one or more embodiments, the disclosed system operates as a continuously running, system-resident engineering environment that establishes and maintains a governed reality-advancing factual-existence infrastructure. The system maintains one or more protected execution regions, one or more system-resident reality stores, one or more evolving system memory substrates, and one or more governance-enforced constitution and supersession engines through which system-resident realities are materially constituted, persisted, registered, sealed, and replaced. The protected execution regions enforce exclusive authority for reality constitution and supersession such that no external participant, peripheral capability, or resource process can directly write, modify, designate, reconstruct, or override canonical system reality.

In one or more embodiments, system-resident reality is constituted as an aggregation of evolutionary micro-reality factual existences rather than as an updatable system state. Advancement of system reality occurs through governed constitution, replacement, and inheritance of evolutionary micro-reality factual existences rather than by modifying a persistent system state. Each evolutionary micro-reality unit constitutes a discrete micro-step of system-recognized reality advancement and is a bounded, self-contained, closed micro-reality factual existence body. Each such micro-reality unit is constituted as a system-resident factual existence body having a system-recognized reality boundary and participation authority, and is not representable as a mere data object, event record, knowledge representation, or computational state. Each micro-reality unit maintains internal continuity relations that render it a closed micro-reality existence loop, such that the unit is not a processing stage, execution stage, decision step, or control unit within a workflow or computational pipeline.

In one or more embodiments, successive evolutionary micro-reality units form continuous fact-flow, which is an evolving continuity of factual existence participating in governed reality advancement rather than a processing pipeline. Within a continuous reality-advancement interval, the system may constitute at least one and optionally a plurality of micro-reality factual entities, each reflecting a respective development of an initial factual existence R₀ in at least one of structural organization, morphological form, relational configuration, contextual participation, or functional positioning. Distinct micro-reality fact-flows are permitted under governance. Divergence is not failure when within axioms, and divergence constitutes alternative admissible factual existences that may persist as distinct realities, may be sealed as terminated realities, or may be consolidated into bounded stage realities when consolidation constraints are satisfied.

In one or more embodiments, the system constitutes at least one task-specific initial factual existence R₀ forming a fuzzy initial reality participation existence. R₀ is not treated as data, a goal specification, a model state, a parameter set, or an optimization target. R₀ constitutes an admitted factual participation existence under axiomatic boundaries and governance constraints, within which subsequent micro-realities may differentiate, mature, stabilize, consolidate, branch, or terminate. Fuzziness at the R₀ stage is not treated as error and is not treated as correctness deficiency, and fuzziness is treated as limited maturity of an admitted factual existence.

In one or more embodiments, canonical system reality is constituted from admitted factual existences under governing realities, admissibility constraints, continuity realities, and memory relations. Canonical system reality is not modified in place. Canonical system reality advances only through governed atomic supersession, by which a successor canonical system reality replaces a prior canonical system reality while preserving lineage. The prior canonical system reality is sealed as historical reality. Historical realities are sealed prior factual existences superseded by successor factual existences and are not event records or logs. Supersession establishes lineage-preserving linkages, inheritance relations, and continuity constraints that participate as reality boundary conditions for subsequent constitution.

In one or more embodiments, the disclosed system maintains a protected canonical reality register in which constituted canonical system realities are materially registered, version-addressed, and jurisdiction-tagged as system-resident realities rather than as data records. The system further maintains a unique current-reality designation structure configured such that, at any given time, exactly one constituted canonical system reality is designated as the current canonical system reality under exclusive system jurisdiction. All other constituted realities are maintained either as sealed historical realities or as non-canonical constituted realities lacking current-designation authority. The unique current-reality designation is altered only through governed atomic supersession, and no external participant, peripheral capability, or internal computational process is permitted to directly designate, overwrite, or reconstruct the current canonical system reality.

In one or more embodiments, at any given time the system designates exactly one constituted canonical system reality as the unique current system reality under exclusive system jurisdiction, and any other constituted realities are maintained only as sealed historical realities or concurrently maintained non-canonical realities lacking current-designation authority.

In one or more embodiments, the system constitutes and maintains one or more purpose realities forming a directional attractor field defining admissible evolutionary direction domains without defining concrete reality configurations, and constituted canonical and bounded realities form a resultant attractor field providing closure, inheritance boundaries, and structural constraints. System reality advances through governed constitution under combined influence of these fields. The directional attractor field supplies admissible directionality under axioms without demanding convergence or prescribing a unique result, and the resultant attractor field supplies closure by imposing what has been constituted and sealed, thereby providing inheritance constraints, continuity boundaries, and structural closure. Purposes are therefore not treated as the same object as results.

In one or more embodiments, the system supports multi-axiomatic governance. A superior axiomatic domain defines non-violable admissibility boundaries, subordinate axiomatic compressions may be constituted for specialized engineering realities, and micro-axioms may be constituted within micro-reality units as localized survivability, coherence, and participation boundaries. Micro-axioms are not computed, inferred, derived, or set as parameters. Micro-axioms are constituted only through factual extraction from admitted occurrences, inheritance from evolving memory substrates, and differentiation from factual conflict among constituted realities, optionally including governed result memories produced by external technologies.

In one or more embodiments, memory within the disclosed system is not passive storage. Memory constitutes a reality substrate and carries continuity, survivability, inheritance, feasibility, and evolution relations. The evolving system memory substrates preserve constituted realities, historical realities, inheritance relations, lineage continuity, contextual associations, and reality evolution paths. Memory may include canonical reality memory, historical reality memory, micro-reality memory, lineage and inheritance structures, resource-associated memory layers, and ephemeral micro-memory and instantaneous memory structures as permitted by constituted system reality.

In one or more embodiments, the evolving system memory substrates further comprise micro-memory and instantaneous memory structures configured to carry ephemeral, high-resolution, and instantaneous reality participation substrates as permitted by constituted system reality. Such micro-memory and instantaneous memory structures enable fine-grained micro-step constitution, localized maturity differentiation, and high-density factual participation without requiring persistent re-computation, continuous algorithmic execution, or sustained simulation cycles. These memory structures participate as lawful reality substrates rather than as caches, buffers, or computational intermediates.

In one or more embodiments, the disclosed system maintains reasoning structures, evolutionary structures, and adjudication structures operating on system-resident factual existences and memory substrates. Reasoning operates as a system-resident infrastructure that evaluates continuity, divergence, compatibility, admissibility, and governance-conditioned interactions. Evolution operates as a system-resident infrastructure through which factual existences differentiate, inherit, recombine, mature, and stabilize. Adjudication operates as a system-resident infrastructure that governs admissibility, viability, survivability, and boundary compliance, and that seals, supersedes, redirects, suspends, consolidates, branches, or terminates realities.

In one or more embodiments, the system collaborates with governed internal and external resources and peripheral capability environments to modify reality formation conditions, survival environments, developmental constraints, and interaction ecologies of factual entities, without conferring authority to constitute, replace, or designate canonical system reality. Resources are treated as fact generators whose outputs are admitted only as governed result memories. The system exposes constituted realities as system-resident reality expressions, and micro-realities, bounded stage realities, and canonical realities may each be selectively exposed, optionally re-admitted as new occurrences, and optionally converted into any external form without surrender of canonical system reality jurisdiction. Failure within the disclosed system is defined as axiomatic boundary violation, non-admissibility adjudication, or irreconcilable factual conflict, divergence within axioms is not failure, and purposes may evolve, compress, branch, suspend, or be newly constituted based on admitted outcomes.

In one or more embodiments, any exposed micro-reality, bounded stage reality, or canonical reality is admissible to be re-admitted only through governed ingress as a new governed occurrence to initiate further reality-advancement cycles without surrender of canonical reality jurisdiction.

In one representative embodiment, the disclosed system is deployed to constitute an agricultural engineering reality in which apples exist within the system not as data records, models, growth curves, or simulation states, but as evolving system-resident factual existences under exclusive system jurisdiction. The embodiment is initiated by admitting heterogeneous internal and external occurrences including seeds, orchard records, cultivation histories, soil and climate observations, genomic references, biochemical assay outcomes, sensor streams, laboratory observations, agricultural narratives, historical production data, and governed result memories generated by external resources such as simulation platforms, analytical engines, sensing systems, or intelligent systems. All such occurrences are admitted exclusively through governed ingress and normalization structures and are normalized into system-recognized governed factual expressions, and no admitted occurrence enters the system as ungoverned data, parameters, or computational state.

From these governed factual expressions, the system constitutes at least one task-specific initial factual existence R₀ as a fuzzy apple-participating reality existence. R₀ is not a biological stage, not a classification, not a parameter set, and not a goal representation. R₀ constitutes an admitted factual participation existence under superior axiomatic agricultural boundaries, expressing that an apple-class reality domain is present within system reality. At the R₀ stage, the apple-participating factual existence may be morphologically indeterminate, structurally under-specified, environmentally unconstrained, temporally open-ended, and internally plural, while remaining admissible under axioms, and fuzziness is treated as limited maturity of factual existence rather than as error.

From R₀, the system successively constitutes evolutionary micro-reality factual existences. Each evolutionary micro-reality is constituted as a closed micro-reality factual existence body having its own system-recognized reality boundary, internal continuity relations, survivability relations, participation authority, and a localized micro-axiomatic domain. Each micro-reality constitutes a discrete micro-step of system-recognized reality advancement and is not a stage of a growth process, not a simulation frame, not a processing state, and not a control step. In this embodiment, evolutionary micro-realities may include, without limitation, seed-existence realities, germination-existence realities, seedling-existence realities, vegetative-existence realities, flowering-existence realities, fruit-formation-existence realities, stress-existence realities, recovery-existence realities, and differentiation-existence realities, and each such micro-reality is a self-contained micro-world in which apple participation is internally coherent and in which memory substrates carry internal continuity, survivability boundaries, and interaction constraints.

Within a single continuous reality-advancement interval, the system may constitute a plurality of micro-realities reflecting different developments of R₀ in structural organization, morphological form, relational configuration, contextual participation, and environmental coupling, and such micro-realities may coexist lawfully as multiple admissible apple worlds. Some micro-realities may express survivability under specific soil realities, some may express morphological stabilization under specific climate couplings, some may express reproductive coherence under ecological interaction realities, and some may express stress-adaptation or degeneration under constraint realities. Such plurality is not treated as branching computation or optimization populations, and is treated as lawful coexistence of factual existences under axioms.

In this embodiment, micro-axioms governing each micro-reality are constituted, not computed, and are constituted only through factual extraction from admitted occurrences, inheritance from evolving system memory substrates including historical apple realities and agricultural lineage relations, and differentiation arising from factual conflict among constituted micro-realities. Additionally, the system may admit governed result memories from external resources including botanical simulations, chemical assays, environmental analytics, sensing systems, and intelligent systems, and such external systems supply no authority and supply only result memories that may be assimilated into evolving memory substrates and may tighten, reshape, or conflict with micro-axioms without dictating reality. Micro-axioms therefore evolve as internal survivability, coherence, and participation boundaries of each apple micro-world.

Throughout this embodiment, evolving system memory substrates operate not as storage but as reality substrates, preserving constituted apple realities, historical apple realities, micro-reality lineage relations, environmental coupling histories, resource-result assimilations, axiomatic compressions, and factual evolution paths. Memory interacts with constitution, reasoning, evolution, and adjudication to enable maturity differentiation, stability recognition, survivability recognition, environmental feasibility recognition, and lawful reality supersession. As micro-realities mature, some satisfy governance, continuity, survivability, and consolidation constraints and are constituted as bounded stage realities, wherein bounded stage realities form stabilized apple worlds, including, without limitation, root-established realities, canopy-stabilized realities, reproductive-coherent realities, and fruit-bearing-coherent realities. Bounded stage realities may be selectively exposed as system-resident reality expressions and may act as resultant attractors influencing subsequent constitution by imposing closure and inheritance boundaries.

Throughout the embodiment, the system maintains dual reality fields, wherein purpose realities define admissible direction domains such as survivability, fruit-bearing admissibility, cultivation feasibility, and varietal coherence without defining specific apple configurations, and constituted canonical and bounded realities form a resultant attractor field imposing closure, inheritance boundaries, continuity constraints, and feasibility limits. Apple reality advances through constitution under the combined influence of these fields, purposes are not results, and results are constituted realities. When successor apple realities are constituted that satisfy canonical consolidation constraints, governed atomic supersession occurs, and the system seals the prior canonical apple reality as historical reality and replaces it with a successor canonical apple reality while preserving lineage. Historical apple realities are sealed factual existences, not logs or records, and lineage relations, inheritance constraints, and continuity boundaries are preserved in evolving memory substrates and participate as boundary conditions for subsequent constitution. When constituted realities stabilize into a canonical configuration corresponding to a varietal apple reality, such as a Fuji-type canonical apple existence, that canonical apple is not a classification result and is a stabilized factual existence configuration constituted under axioms, memory, reasoning, evolution, and adjudication. At any time, the system may expose micro-realities, bounded stage realities, and canonical apple realities as system-resident reality expressions, and such outputs may be selectively used by beneficiaries, optionally re-admitted as new occurrences, and optionally converted into any external form without surrender of canonical reality jurisdiction.

In another representative embodiment, the disclosed system is deployed to constitute an irrigation engineering reality derived from, constrained by, and structurally participating in a previously constituted apple growth engineering reality. This embodiment does not begin from abstract requirements, control objectives, or system parameters, and begins from an already constituted system-resident apple reality world that exists within the system as a lineage-preserved factual existence environment under exclusive system jurisdiction.

The embodiment is initiated by admitting, through governed ingress, a reality-construction declaration specifying that a new governed reality domain is to be constituted for irrigation participation within the constituted apple engineering world. The system constitutes, based thereon, a new irrigation-domain purpose reality forming a directional attractor field that establishes admissible irrigation participation within apple survivability, maturation, and productivity axioms, without defining any concrete irrigation structure, mechanism, or strategy. The system further constitutes subordinate axiomatic compressions derived from the superior agricultural axioms of the apple world, including survivability axioms, resource axioms, and interaction axioms, and such compressions form admissibility boundaries within which irrigation realities may lawfully exist.

Occurrences admitted for this irrigation domain include, without limitation, water-source realities, soil moisture observations, hydrological conditions, irrigation infrastructure descriptions, material properties, flow and pressure observations, nutrient transport realities, sensor streams, human engineering narratives, maintenance histories, environmental coupling facts, and governed result memories generated by external resources such as fluid simulations, hydraulic solvers, sensing platforms, analytics engines, manufacturing systems, and intelligent systems. All such occurrences are admitted exclusively through governed ingress and normalization and are constituted into system-recognized governed factual expressions.

From these governed factual expressions, the system constitutes a task-specific initial irrigation factual existence R₀′ as a fuzzy irrigation-participating reality existence. R₀′ is not a design specification, not a topology, not a control policy, and not an optimization objective, and R₀′ constitutes an admitted irrigation participation existence under irrigation axioms, apple participation constraints, and superior agricultural axioms. At this stage, the irrigation factual existence may be structurally indeterminate, spatially undefined, environmentally unconstrained, technologically plural, and internally inconsistent, while remaining admissible under axioms, and fuzziness of R₀′ is treated as limited maturity of irrigation reality rather than as error.

From R₀′, the system successively constitutes evolutionary micro-reality factual existences, each forming a closed irrigation micro-world. Each irrigation micro-reality is constituted as a bounded factual existence body carrying an internal irrigation participation boundary, survivability relations under water and material axioms, coupling relations to apple micro-realities, internal micro-memory substrates, and a localized micro-axiomatic domain. In this embodiment, irrigation micro-realities may include, without limitation, water-intake existence realities, distribution-existence realities, delivery-existence realities, soil-coupling realities, root-zone participation realities, nutrient-integration realities, failure-survivability realities, seasonal-adaptation realities, and maintenance-participation realities. Each such micro-reality is a self-contained irrigation world that supersedes and inherits prior irrigation micro-realities while remaining structurally subordinate to apple canonical realities.

Within a single reality-advancement interval, the system may constitute multiple irrigation micro-realities reflecting different developments of R₀′ in structural organization, material composition, relational coupling, contextual participation, environmental interaction, and functional positioning, and distinct irrigation fact-flows may coexist lawfully as multiple admissible irrigation worlds. Such plurality is not treated as competing solutions and is treated as coexistence of factual existences under axioms.

Each irrigation micro-reality carries micro-axioms constituted through factual extraction from admitted irrigation occurrences, inheritance from evolving irrigation and apple memory substrates, and differentiation arising from factual conflict among irrigation micro-realities or between irrigation and apple realities. Additionally, governed result memories produced by external technologies, such as hydraulic simulations, stress analyses, nutrient transport models, or AI-generated structural outcomes, may be admitted and assimilated, and such result memories may tighten survivability boundaries, introduce new factual relations, differentiate micro-axioms, or invalidate certain irrigation realities, without ever constituting canonical irrigation reality. Throughout this embodiment, evolving system memory substrates integrate historical apple realities, historical irrigation realities, micro-reality lineage relations, resource-result assimilations, environmental coupling memories, material feasibility memories, and micro-axiomatic compressions, and memory functions as a reality substrate enabling irrigation realities to inherit survivability relations, feasibility boundaries, and continuity constraints without re-computation.

As irrigation micro-realities mature, some satisfy consolidation constraints and are constituted as bounded irrigation stage realities, including, without limitation, stable intake realities, distribution-coherent realities, delivery-coherent realities, soil-integration realities, failure-resilient realities, and maintenance-sustainable realities, and such bounded irrigation realities may be exposed as system-resident reality expressions and may act as resultant attractors influencing further irrigation constitution. Irrigation reality advancement is governed by dual attractor interaction, wherein purpose realities define admissible irrigation directionality such as sufficient hydration participation, nutrient delivery participation, environmental compatibility, resource feasibility, and survivability under variability, and resultant attractors are formed by constituted apple canonical realities, constituted irrigation bounded realities, and sealed historical irrigation realities that impose closure, inheritance boundaries, and feasibility constraints. When irrigation realities stabilize into successor canonical irrigation realities, governed atomic supersession occurs, and the system seals prior canonical irrigation realities as historical irrigation realities and replaces them with successor canonical irrigation realities while preserving lineage relations back to apple realities, and canonical irrigation realities are thereby system-resident engineering worlds rather than system configurations.

At any time, the system may expose irrigation micro-realities, bounded irrigation stage realities, and canonical irrigation realities as system-resident reality expressions, and such outputs may be selectively used by beneficiaries and may be converted into external forms such as manufacturing artifacts, deployment specifications, installation configurations, monitoring frameworks, or operational coordination interfaces, without surrender of canonical irrigation reality jurisdiction. The disclosed system thereby constitutes irrigation engineering not as control systems, designs, or optimization results, but as a system-resident irrigation reality world that evolves, inherits, and stabilizes through governed factual existence constitution.

In another representative embodiment, the disclosed system is deployed in a domain in which an initial external submission is ambiguous, incomplete, underspecified, internally inconsistent, or contextually plural, and in which neither the initial system purpose nor the initial factual basis corresponds to a determinate target configuration. This embodiment illustrates constitution of an engineering reality in which intelligent systems, analytical systems, and simulation systems participate only as governed peripheral resources and never as reality authorities.

Occurrences admitted in this embodiment may include heterogeneous and unstructured submissions including observational records, partial measurements, linguistic descriptions, sensory streams, historical fragments, human experiential narratives, machine-generated outputs, simulation outputs, analytical outcomes, and intelligent-system outputs. All such occurrences are admitted exclusively through governed ingress and normalization structures and are normalized into system-recognized governed factual expressions prior to any participation in reality formation. None of the admitted occurrences enter the system as tasks, hypotheses, goals, labels, control signals, or computational states.

From these governed factual expressions, the system constitutes at least one task-specific initial factual existence R₀″ as a fuzzy, multi-valued, and open-ended factual participation existence admissible under superior axioms. R₀″ is not a problem statement, not a prediction objective, and not a data structure. R₀″ constitutes an admitted factual existence indicating that a new reality participation domain has entered system jurisdiction under axioms. At the R₀″ stage, the factual existence may be morphologically indeterminate, structurally under-specified, environmentally unconstrained, temporally open-ended, internally plural, and partially contradictory while remaining admissible, and fuzziness is treated as limited maturity of factual existence rather than as error.

From R₀″, the system successively constitutes evolutionary micro-reality factual existences, each constituted as a closed micro-reality factual existence body having its own system-recognized reality boundary, internal continuity relations, survivability relations, participation authority, internal micro-memory substrates, and a localized micro-axiomatic domain. Each micro-reality constitutes a discrete micro-step of system-recognized reality advancement and is not a reasoning step, not an inference stage, not a training iteration, and not a decision cycle.

Within a single reality-advancement interval, the system may constitute a plurality of micro-realities reflecting different admissible factual developments of R₀″ under axioms, including developments that diverge in structural organization, relational configuration, contextual participation, environmental coupling, functional positioning, or survivability participation. Such plurality is not treated as hypothesis populations or optimization populations and is treated as lawful coexistence of factual existences under axioms, wherein each micro-reality may carry its own micro-axiomatic compression and its own lineage continuity.

In this embodiment, intelligent systems, analytical systems, and simulation systems may be invoked as governed peripheral resources to generate result memories. Such external systems may perform recognition, analysis, synthesis, prediction, generation, or transformation, and their outputs are admitted only as governed result memories. These result memories may be assimilated into evolving memory substrates, may influence micro-axioms, may invalidate micro-realities, may tighten survivability boundaries, or may introduce new factual relations, but no external system output has authority to constitute, supersede, or designate canonical system reality.

Throughout this embodiment, evolving system memory substrates operate as reality substrates and not as storage. Memory preserves constituted realities, sealed historical realities, micro-reality lineages, contextual couplings, resource-result assimilations, and axiomatic compressions. Memory enables the system to advance realities through inheritance and supersession rather than through continuous recomputation, and to treat sealed historical realities as inherited conditions rather than as logs.

As micro-realities mature, some satisfy governance, survivability, coherence, and consolidation constraints and are constituted as bounded stage realities. Bounded stage realities form stabilized reality worlds that may be selectively exposed as system-resident reality expressions and may act as resultant attractors influencing subsequent constitution by imposing closure and inheritance boundaries.

Throughout this embodiment, the system maintains dual reality fields. Purpose realities constitute a directional attractor field defining admissible direction domains without defining concrete reality configurations and without demanding convergence. Constituted canonical and bounded realities constitute a resultant attractor field providing closure, inheritance boundaries, continuity constraints, and feasibility limits imposed by what has been constituted and sealed. When successor realities satisfy canonical consolidation constraints, governed atomic supersession occurs, and the system seals prior canonical realities as historical realities and replaces them with successor canonical realities while preserving lineage. Purposes and results are not required to coincide.

At any time, the system may expose micro-realities, bounded stage realities, and canonical realities as system-resident reality expressions. Such exposed realities may be selectively used by beneficiaries, may be converted into any external form, and may be re-admitted only through governed ingress as new occurrences for subsequent reality-advancement cycles without surrender of canonical reality jurisdiction.

In another representative embodiment, the disclosed system is deployed to constitute an industrial engineering reality in which industrial entities, infrastructures, and processes exist within the system not as operational states, not as workflows, and not as control systems, but as evolving system-resident factual existences under exclusive system jurisdiction.

Occurrences admitted in this embodiment may include physical artifacts, material properties, manufacturing histories, structural descriptions, operational observations, maintenance narratives, environmental interactions, sensor streams, inspection outcomes, human engineering descriptions, and governed result memories generated by external resources such as simulations, analytics, industrial control systems, digital platforms, and intelligent systems. All such occurrences are admitted exclusively through governed ingress and normalization and are normalized into system-recognized governed factual expressions.

From these governed factual expressions, the system constitutes at least one task-specific initial industrial factual existence R₀′″ as a fuzzy industrial-participating reality existence. R₀′″ is not a design specification, not a production plan, not a process description, and not a control objective. R₀′″ constitutes an admitted factual participation existence under industrial axioms and superior axioms.

From R₀′″, the system successively constitutes evolutionary micro-reality factual existences, each forming a closed industrial micro-world. Each industrial micro-reality is constituted as a bounded factual existence body carrying an internal participation boundary, survivability relations, coupling relations to environmental and resource realities, internal micro-memory substrates, and a localized micro-axiomatic domain. Industrial micro-realities may include, without limitation, material-existence realities, assembly-existence realities, operational-existence realities, maintenance-existence realities, failure-existence realities, and recovery-existence realities.

Within a continuous reality-advancement interval, the system may constitute multiple industrial micro-realities reflecting different developments of R₀′″, and such micro-realities may coexist lawfully under axioms. Micro-axioms governing each micro-reality are constituted through factual extraction from admitted occurrences, inheritance from evolving system memory substrates, and differentiation arising from factual conflict. Governed result memories produced by external technologies may be assimilated without conferring authority.

As industrial micro-realities mature, some satisfy consolidation constraints and are constituted as bounded industrial stage realities, including, without limitation, stability-coherent realities, performance-coherent realities, safety-coherent realities, and maintenance-sustainable realities. Bounded industrial realities may be selectively exposed as system-resident reality expressions and may act as resultant attractors influencing subsequent constitution.

Industrial reality advancement is governed by dual attractor interaction, wherein purpose realities define admissible industrial directionality without prescribing results, and resultant attractors are formed by constituted and sealed realities that impose closure, inheritance boundaries, and feasibility constraints. When successor industrial realities satisfy canonical consolidation constraints, governed atomic supersession occurs, and the system seals prior canonical industrial realities as historical industrial realities and replaces them with successor canonical industrial realities while preserving lineage.

At any time, the system may expose industrial micro-realities, bounded industrial stage realities, and canonical industrial realities as system-resident reality expressions. Such outputs may be selectively used by beneficiaries and may be converted into external forms such as manufacturing artifacts, deployment frameworks, monitoring architectures, or coordination infrastructures without surrender of canonical industrial reality jurisdiction.

In another representative embodiment, the disclosed system is deployed to constitute an environmental and ecological engineering reality in which environmental entities, ecological relations, and environmental dynamics exist within the system as evolving system-resident factual existences under exclusive system jurisdiction.

Occurrences admitted in this embodiment may include environmental observations, climate records, biological interactions, ecological narratives, chemical and physical measurements, satellite imagery, sensor networks, historical environmental events, and governed result memories generated by external resources such as environmental simulations, predictive analytics, modeling platforms, and intelligent systems. All such occurrences are admitted exclusively through governed ingress and normalization and are normalized into system-recognized governed factual expressions.

From these governed factual expressions, the system constitutes at least one task-specific initial environmental factual existence R₀⁴ as a fuzzy environmental-participating reality existence admissible under superior environmental axioms. R₀⁴ is not an environmental model, not a dataset, and not a prediction target.

From R₀⁴, the system successively constitutes evolutionary micro-reality factual existences, each forming a closed environmental micro-world carrying its own participation boundary, survivability relations, coupling relations, internal micro-memory substrates, and localized micro-axioms. Environmental micro-realities may include, without limitation, habitat-existence realities, interaction-existence realities, disturbance-existence realities, recovery-existence realities, resilience-existence realities, and transformation-existence realities.

Within a continuous reality-advancement interval, the system may constitute multiple environmental micro-realities reflecting different developments of R₀⁴, and such micro-realities may coexist lawfully. Governed result memories from external resources may be assimilated without authority.

As environmental micro-realities mature, some satisfy consolidation constraints and are constituted as bounded environmental stage realities, including, without limitation, stability-coherent realities, resilience-coherent realities, and sustainability-coherent realities. Bounded environmental realities may be selectively exposed as system-resident reality expressions and may act as resultant attractors influencing subsequent constitution.

Environmental reality advancement is governed by dual attractor interaction, and when successor environmental realities satisfy canonical consolidation constraints, governed atomic supersession occurs, and the system seals prior canonical environmental realities as historical environmental realities and replaces them with successor canonical environmental realities while preserving lineage.

At any time, the system may expose environmental micro-realities, bounded environmental stage realities, and canonical environmental realities as system-resident reality expressions, and such outputs may be selectively used by beneficiaries and converted into any external form without surrender of canonical environmental reality jurisdiction.

In another representative embodiment, the disclosed system is deployed to constitute project-scoped, distributed, or federated engineering realities in which multiple engineering reality worlds participate under superior axioms while remaining system-resident factual existences under exclusive system jurisdiction.

Occurrences admitted in this embodiment may include project declarations, inter-system interaction facts, distributed environmental observations, cross-domain participation narratives, infrastructural descriptions, and governed result memories generated by external systems. All such occurrences are admitted exclusively through governed ingress and normalization and are normalized into system-recognized governed factual expressions.

From these governed factual expressions, the system constitutes at least one task-specific initial project factual existence R₀⁵ as a fuzzy project-participating reality existence admissible under superior axioms. From R₀⁵, the system successively constitutes evolutionary micro-reality factual existences forming closed project micro-worlds, each carrying participation boundaries, survivability relations, coupling relations to other constituted realities, internal micro-memory substrates, and localized micro-axioms.

Within a continuous reality-advancement interval, the system may constitute multiple project micro-realities reflecting different developments of R₀⁵, and such micro-realities may coexist lawfully. Governed result memories from external and distributed resources may be assimilated without authority.

As project micro-realities mature, some satisfy consolidation constraints and are constituted as bounded project stage realities. Project reality advancement is governed by dual attractor interaction, and when successor project realities satisfy canonical consolidation constraints, governed atomic supersession occurs, and the system seals prior canonical project realities as historical project realities and replaces them with successor canonical project realities while preserving lineage across federated domains.

At any time, the system may expose project micro-realities, bounded project stage realities, and canonical project realities as system-resident reality expressions, and such outputs may be selectively used by beneficiaries and converted into any external form without surrender of canonical project reality jurisdiction.

In one or more embodiments, the disclosed system further establishes structured reality registration, sealing, exposure, and jurisdiction infrastructures configured to operate across all constituted engineering reality worlds. These infrastructures are system-resident and enforce exclusive system jurisdiction over constitution, supersession, designation, and lineage preservation for all realities irrespective of domain, scale, or federation.

In one or more embodiments, the system maintains reality registration structures configured to materially register constituted micro-realities, bounded stage realities, and canonical realities as system-resident factual existences. Registration includes reality addressing, lineage association, axiomatic association, and jurisdiction tagging. Registered realities are not data entries and are not records, and registration does not confer mutability authority. Registration establishes that a constituted factual existence has entered system reality jurisdiction and participates as a recognized reality object within evolving memory substrates.

In one or more embodiments, the system further maintains sealing structures configured to seal constituted realities as historical realities upon supersession, termination, or consolidation. Sealing operates as a material system action by which a constituted factual existence is rendered non-current and preserved as a sealed historical reality. Sealed historical realities remain present as factual existences within evolving system memory substrates and are not converted into event logs, audit trails, or archival records. Sealed historical realities carry lineage relations, inheritance constraints, contextual couplings, and survivability boundaries that remain materially active in subsequent constitution.

In one or more embodiments, the system maintains reality exposure infrastructures configured to expose constituted realities as system-resident reality expressions. Exposure is not export of data and is not transmission of internal system state. Exposure establishes an interface through which constituted factual existences may be accessed, visualized, interacted with, or utilized by authorized system processes, beneficiaries, assisted mechanisms, automated mechanisms, or mixed mechanisms without conferring authority to alter, designate, or reconstruct canonical system reality.

In one or more embodiments, the disclosed system establishes dual system output modes comprising (i) direct system-native exposure of system-resident reality expressions, and (ii) governed external conversion and projection into any external form. The system further maintains beneficiary selection structures configured to permit selective use of exposed realities by system processes, authorized entities, beneficiaries, automated mechanisms, assisted mechanisms, or mixed selection mechanisms.

In one or more embodiments, the disclosed system further establishes governed re-admission structures configured to permit any exposed micro-reality, bounded stage reality, or canonical reality to be re-admitted as a new governed occurrence for subsequent reality-advancement cycles. All exposure, selection, conversion, and re-admission operations are structurally prevented from conferring external authority over constitution, supersession, or designation of canonical system reality, and exclusive system jurisdiction over system-resident reality is preserved across all output modes.

In one or more embodiments, the disclosed system further supports distributed, multi-domain, and federated operation in which multiple constituted engineering reality worlds coexist within a superior axiomatic environment. Federated realities remain system-resident factual existences under exclusive system jurisdiction. Federated participation may include cross-domain coupling, cross-reality inheritance, cross-axiomatic participation, and coordinated supersession events, without surrender of reality authority to any participating external system, agent, or computational environment.

In one or more embodiments, the disclosed system further establishes system-resident monitoring, audit, and verification infrastructures configured to operate on constituted realities, lineage relations, axiomatic compliance, and governance enforcement. Monitoring, audit, and verification infrastructures operate on system-resident factual existences and memory substrates and do not operate as control systems. These infrastructures may produce governed result memories reflecting compliance, divergence, survivability, stability, or violation, and such result memories may be assimilated into evolving system memory substrates and may influence adjudication, supersession, or consolidation without conferring authority.

In one or more embodiments, the disclosed system further supports suspension, termination, and reconstruction of constituted realities. Suspension renders a constituted factual existence non-participatory while preserving it as a sealed historical reality. Termination seals a constituted factual existence as historically closed under governance. Reconstruction operates by constituting a successor factual existence that inherits selected lineage relations, axiomatic compressions, and contextual couplings from sealed historical realities without reconstructing or modifying sealed realities.

In one or more embodiments, the disclosed system further establishes system-resident security, integrity, and survivability infrastructures configured to protect evolving memory substrates, protected execution regions, governance authorities, and lineage relations. These infrastructures may include cryptographic protections, hardware-enforced isolation, distributed redundancy, fault survivability structures, and jurisdiction enforcement mechanisms. Such infrastructures operate to protect the reality formation environment rather than to control or optimize constituent systems.

In one or more embodiments, the disclosed system may be embodied within a single computing environment, a distributed computing environment, a cyber-physical environment, a hybrid hardware-software environment, a networked infrastructure, or a federated multi-system environment. Implementation choices do not alter the system ontology, and constituted factual existences remain system-resident realities irrespective of embodiment.

In one or more embodiments, the disclosed system thereby establishes a continuously running reality-advancing engineering environment in which reality itself is a protected system artifact, advanced through constitution, lineage-preserving supersession, and evolving memory substrates rather than through algorithmic update, control execution, or model recomputation.

1. A system embodied in non-transitory machine memory, comprising one or more processors, the system being configured to operate as a continuously running system-resident engineering environment that establishes and maintains a governed reality-advancing factual-existence infrastructure,
wherein the system maintains protected execution regions, evolving system memory substrates, and governance-enforced constitution and supersession engines through which system-resident realities are materially constituted, preserved, inherited, and replaced under exclusive system jurisdiction;
wherein the system establishes a protected system-resident reality domain within which constituted realities exist as protected system artifacts rather than as computed states, models, representations, or informational objects;
wherein any internal or external occurrence of any form is admitted only through system-enforced governed ingress and normalization structures and is normalized into system-recognized governed factual expressions prior to participation in reality formation;
wherein the system constitutes, from admitted governed factual expressions, at least one task-specific initial factual existence R₀ forming a fuzzy initial reality participation existence admissible under axiomatic boundaries;
wherein the system constitutes system-resident reality not as an updatable system state but as an aggregation of evolutionary micro-reality factual existences;
wherein the system successively constitutes evolutionary micro-reality units from R₀-derived factual existences, each evolutionary micro-reality unit constituting a bounded, self-contained, closed micro-reality factual existence body forming a discrete micro-step of system-recognized reality advancement, successive evolutionary micro-reality units forming continuous fact-flow;
wherein within a continuous reality-advancement interval the system is configured to constitute a plurality of evolutionary micro-reality factual existences reflecting different factual developments of R₀ in at least one of structural organization, morphological form, relational configuration, contextual participation, or functional positioning;
wherein bounded stage realities comprise selected evolutionary micro-reality units that satisfy governance, continuity, survivability, or consolidation constraints, all bounded stage realities being evolutionary micro-realities but not all evolutionary micro-realities constituting bounded stage realities;
wherein the system constitutes and maintains (i) one or more purpose realities forming a directional attractor field defining admissible evolutionary direction domains without defining concrete reality configurations, and (ii) constituted canonical system realities forming a resultant attractor field providing closure, inheritance boundaries, and continuity constraints;
wherein advancement of system reality is performed through governed reality constitution and governed atomic supersession under a combined influence of the directional attractor field and the resultant attractor field;
wherein the system performs governed atomic supersession by which a successor canonical system reality replaces a prior canonical system reality while sealing the prior canonical system reality as a historical factual existence and preserving lineage relations;
wherein the system maintains evolving system memory substrates preserving constituted realities, historical realities, micro-realities, lineage relations, inheritance relations, contextual associations, micro-axiomatic formations, and reality evolution paths, memory constituting a system-resident reality substrate rather than passive storage;
wherein the system maintains reasoning, monitoring, and adjudication structures operating on system-resident realities, micro-realities, axiomatic boundaries, and memory substrates to recognize factual relations, continuity, divergence, admissibility, and axiomatic compliance;
wherein the system collaborates, under governance, with internal and external resources and peripheral capability environments solely to obtain governed result memories treated as factual materials, without conferring authority to such resources to constitute, replace, or designate canonical system reality;
wherein each evolutionary micro-reality unit constitutes a closed factual existence loop having a system-recognized reality boundary and participation authority and is not representable as a data object, computational state, workflow stage, or control unit;
wherein no canonical system reality or evolutionary micro-reality unit is derived by algorithmic computation, inference, learning, optimization, or transformation of a prior system state;
and wherein the system exposes evolutionary micro-realities, bounded stage realities, and canonical system realities as system-resident reality expressions selectively usable by system processes, authorized entities, or beneficiaries and convertible into any external form without conferring external authority over canonical system reality.

2. The system of claim 1, wherein resolution of system reality advancement is defined by system-recognized boundaries of evolutionary micro-reality units rather than by computational precision or sampling frequency.

3. The system of claim 1, wherein temporal and spatial resolution of system reality are defined by spatiotemporal boundaries of constituted evolutionary micro-reality units.

4. The system of claim 1, wherein each governed atomic supersession generates a sealed historical system reality and a lineage-preserving supersession linkage.

5. The system of claim 1, wherein the evolving system memory substrates comprise canonical reality memory, historical reality memory, micro-reality memory, lineage and inheritance memory, and governed resource-associated memory layers.

6. The system of claim 1, wherein each evolutionary micro-reality unit is associated with a respective multi-dimensional independent coordinate framework defining spatiotemporal, relational, structural, functional, or contextual references.

7. The system of claim 1, wherein in high-resolution reality-advancement contexts a natural reality stage comprises a plurality of evolutionary micro-realities.

8. A method performed by a continuously running system-resident engineering environment embodied in non-transitory machine memory, comprising establishing and maintaining a governed reality-advancing factual-existence infrastructure,
wherein system-resident realities are constituted as protected system artifacts rather than as computed states;
wherein internal and external occurrences are admitted only through governed ingress and normalization and normalized into governed factual expressions;
wherein at least one task-specific initial factual existence R₀ is constituted forming a fuzzy initial reality participation existence admissible under axiomatic boundaries;
wherein evolutionary micro-reality factual existences are successively constituted as closed micro-reality bodies forming discrete micro-steps of system-recognized reality advancement;
wherein bounded stage realities are constituted from selected evolutionary micro-realities satisfying governance, continuity, or survivability constraints;
wherein canonical system realities are advanced only by governed atomic supersession sealing prior canonical realities as historical factual existences while preserving lineage relations;
wherein evolving system memory substrates preserve constituted realities, historical realities, micro-realities, axiomatic relations, and reality evolution paths as a system-resident reality substrate;
wherein purpose realities form a directional attractor field and constituted canonical realities form a resultant attractor field under whose combined influence reality is constituted and advanced;
wherein internal and external resources are invoked only to generate governed result memories treated as factual materials without authority to constitute system reality;
and wherein system-resident reality expressions comprising evolutionary micro-realities, bounded stage realities, and canonical realities are selectively exposed and optionally converted into any external form without surrender of system reality jurisdiction.

9. The method of claim 8, wherein resolution of system reality advancement is defined by boundaries of evolutionary micro-reality units.

10. The method of claim 8, wherein evolutionary micro-reality units constitute bounded closed factual existence loops rather than processing stages.

11. The method of claim 8, wherein canonical system realities are not modified in place and are advanced only by atomic supersession.

12. The method of claim 8, wherein evolutionary micro-reality units are associated with independent multi-dimensional coordinate frameworks.

13. The method of claim 8, wherein a plurality of evolutionary micro-realities are constituted concurrently under differentiated micro-axiomatic compressions and governed adjudication determines continuation, divergence, sealing, or termination.

14. A non-transitory machine-readable storage medium storing instructions that, when executed by one or more processors, cause a continuously running system-resident engineering environment to perform operations comprising establishing and maintaining a governed reality-advancing factual-existence infrastructure,
wherein system-resident realities are constituted as protected system artifacts;
wherein occurrences are admitted only through governed ingress and normalization;
wherein a fuzzy initial factual existence R₀ is constituted;
wherein evolutionary micro-reality factual existences are successively constituted as closed micro-reality bodies;
wherein canonical system realities are advanced only through governed atomic supersession preserving lineage;
wherein evolving system memory substrates preserve constituted realities, historical realities, micro-realities, axiomatic relations, and evolution paths;
wherein purpose realities form a directional attractor field and constituted canonical realities form a resultant attractor field;
wherein internal and external resources provide only governed result memories;
and wherein evolutionary micro-realities, bounded stage realities, and canonical realities are exposed as system-resident reality expressions convertible into any external form without surrender of system reality jurisdiction.

15. The storage medium of claim 14, wherein resolution of reality advancement is defined by micro-reality boundaries rather than computational precision.

16. The storage medium of claim 14, wherein evolutionary micro-realities constitute bounded closed factual existence bodies.

17. The storage medium of claim 14, wherein canonical system realities are advanced only through atomic supersession.

18. The storage medium of claim 14, wherein evolving system memory substrates comprise canonical, historical, micro-reality, lineage, and resource-associated memory layers.

19. The storage medium of claim 14, wherein no constituted system reality is representable as a data object, model, simulation state, or computational state.

20. The storage medium of claim 14, wherein system-resident reality expressions are selectively usable by system processes, authorized entities, beneficiaries, automated mechanisms, assisted mechanisms, or mixed selection mechanisms.
